(19) United States
(12) Patent Application Publication
(10) Pub. No.: US 2026/0338636 A1
(43) Pub. Date: Oct. 29, 2026

(54) ABERRATION MEASUREMENT APPARATUS AND METHOD BY FAST IMAGE PLANE SCANNING WITH OPTICAL UNIT

(71) Applicant: SD OPTICS, INC., SEOUL (KR)

(72) Inventors: YOHAN KIM, Seoul (KR); JIN YOUNG SOHN, Seoul (KR); CHEONG SOO SEO, Seoul (KR)

(21) Appl. No.: 19/188,504

(22) Filed: Apr. 24, 2025

(51) Int. Cl. G01M 11/02; G02B 21/06; G02B 21/36

(52) U.S. Cl. CPC G01M 11/0264; G01M 11/0207; G02B 21/06; G02B 21/361

(57) ABSTRACT

The present invention relates to an advanced aberration measurement apparatus and method for quantifying optical aberrations in optical systems, particularly those used in microscopy. The apparatus comprises an optical unit incorporating a variable focusing optical element, which enables rapid image plane scanning by dynamically adjusting focus without requiring mechanical movement. Multiple images are captured at different focal depths and processed by dedicated software to determine best focus positions. The proposed method provides higher speed, improved accuracy, and automation compared to traditional aberration measurement techniques, minimizing the need for manual calibration and complex mechanical adjustments. The invention is adaptable to various optical systems, enhancing the performance and precision of high-resolution imaging instruments.

### FIELD OF THE INVENTION

The present invention relates to optical testing and measurement systems, particularly to an aberration measurement apparatus and method utilizing fast image plane scanning. The invention is designed for precise determination of optical aberrations in various optical systems, such as microscopes, by employing an optical unit with a variable focusing optical element.

### BACKGROUND OF THE INVENTION

Optical systems are subject to various sources of error, including design imperfections, manufacturing tolerances, and environmental factors. While optical design simulations and tolerance analysis can help mitigate design and fabrication errors, measurement errors remain particularly challenging to predict and control. These errors introduce deviations from the intended optical performance, making it difficult to isolate and correct the underlying causes of optical aberrations.

Optical aberrations are among the most significant contributors to performance degradation in optical systems. To accurately assess these aberrations, it is essential to measure wavefront errors and express them mathematically, often using Zernike polynomials. Several approaches have been developed for this purpose, each with distinct advantages and limitations.

One of the most widely used methods for aberration measurement is Shack-Hartmann wavefront sensing, illustrated in FIG. 1. The Shack-Hartmann wavefront sensor 100 employs a microlens array 101 that divides an incoming wavefront 104 into multiple beamlets, which are then focused onto a sensor 102. The sensor records the displacement of focal spots 103, allowing the wavefront to be reconstructed by analyzing local phase variations. This technique provides high precision but requires a complex optical setup and is highly sensitive to environmental disturbances, making it unsuitable for unstable conditions or broadband imaging systems.

Another widely used approach is interferometry, including Twyman-Green interferometers, which analyze interference patterns to quantify wavefront errors. Referring to FIG. 2, a Twyman-Green interferometer is illustrated. This setup is widely used for wavefront analysis and optical aberration measurement. The system consists of a coherent light source 201, typically a laser, that is collimated using a lens system 202. A beam splitter 203 divides the beam into a reference path and a test path. The reference beam is reflected by a reference mirror 204, while the test beam passes through the optical system under test 205, which introduces wavefront errors. The distorted wavefront is then reflected by a spherical mirror 206. The two beams recombine at the beam splitter 203 and interfere, forming an interference pattern that is captured by an imaging system, such as a CCD or CMOS sensor 208, with a focusing lens 207. The recorded interference fringes provide information about the wavefront aberrations present in the optical system. While the Twyman-Green interferometer provides high accuracy in optical aberration measurements, it has several limitations. It is highly sensitive to mechanical vibrations and environmental disturbances, requiring a stable setup. Moreover, precise alignment of optical components is critical, making it difficult to use in real-time or high-throughput applications. Additionally, the analysis of interference fringes requires complex computational processing to extract aberration coefficients, increasing the overall complexity of the method.

Neural-network-based wavefront reconstruction is another technique in which a sequence of images is captured at different focal depths, and computational algorithms are used to reconstruct the optical wavefront. While this method does not require additional optical components, it is computationally intensive and depends on large training datasets to achieve accurate reconstructions. Furthermore, its reliability is highly dependent on the diversity and quality of the training data, which can limit its applicability in general-purpose aberration measurement.

Intensity-based focus scanning techniques have also been employed for aberration measurement. These methods involve capturing a sequence of images at varying focal depths and analyzing intensity variations to infer aberrations. Conventional implementations of these methods rely on mechanical movement of optical components, such as axial displacement of lenses or translation of the test target. However, mechanical scanning introduces alignment errors, increases measurement time, and requires frequent recalibration, limiting its practicality for fast or automated systems. A well-known example of an intensity-based focus scanning technique is Through-Focus Modulation Transfer Function (TF-MTF) measurement, which evaluates contrast transfer function (CTF) variations across different focal planes to quantify optical aberrations. Another approach is Through-Focus Energy Spread Function (TF-ESF) analysis, where intensity distribution changes are analyzed as the focal plane is shifted. While these methods provide valuable aberration data, their reliance on mechanical scanning reduces their suitability for real-time applications.

Despite their effectiveness, conventional aberration measurement techniques share several critical limitations, including 1) dependency on mechanical movement, leading to misalignment and longer measurement times, 2) high sensitivity to environmental factors, such as vibrations and temperature fluctuations, 3) complexity in optical setup, requiring precise calibration and additional components, and 4) limited adaptability to different optical systems, as many techniques require modifications to the optical path.

Many of these methods require dedicated optical paths or modifications to the existing optical system configuration, making them difficult to integrate into pre-existing instruments. There remains a need for an aberration measurement system that eliminates mechanical movement, improves measurement speed, and seamlessly integrates with existing optical systems without requiring modifications.

### SUMMARY OF THE INVENTION

Existing optical aberration measurement techniques, such as Shack-Hartmann sensors, interferometry, and intensity-based focus scanning, have demonstrated high precision but often rely on mechanical movement, complex calibration procedures, or dedicated optical paths. These requirements limit their adaptability to existing optical systems, as they frequently necessitate modifications to the optical layout or physical integration. As a result, such techniques are challenging to incorporate into compact, high-throughput, or already optimized optical instruments used in research, industrial, or medical applications.

The present invention overcomes these limitations by introducing a high-speed, non-mechanical aberration measurement apparatus based on a variable focusing optical element. This element dynamically adjusts the image plane without mechanical translation, enabling rapid acquisition of through-focus image stacks. Unlike conventional wavefront sensors or interferometers, the proposed system can be directly attached to the camera port of a microscope, telescope, or other optical device, without requiring changes to the existing optical configuration.

The captured image sequences are analyzed using focus evaluation algorithms such as Sum Modified Laplacian (SML), Gray-Level Local Variance (GLLV) or Tenengrad to determine best focus positions across the field of view. These positions are then fitted using Zernike polynomial decomposition to quantify common optical aberrations, including defocus, astigmatism, coma, and spherical aberration, etc.

The modular design of the present invention allows it to be adapted to a wide range of optical systems. Its compact form factor and ability to integrate without altering the existing optical configuration make it particularly well-suited for precision applications in scientific imaging, industrial inspection, and optical system calibration. The absence of macro moving parts ensures high measurement repeatability and eliminates alignment errors typically associated with mechanical scanning systems.

In addition to the core configuration, the present invention provides both standard and illumination-integrated alternatives of the aberration measurement apparatus. These include versions without built-in illumination for use with existing external light sources, as well as compact, self-contained designs incorporating internal illumination systems. Among the proposed configurations, a coaxial illumination geometry is particularly emphasized. In this setup, the illumination and imaging beams share the same optical axis, simplifying alignment and enhancing system stability. A polarizing beam splitter and a retarder are used within the optical path to manage polarization states, thereby increasing optical throughput and overall efficiency. This design enables high-contrast, uniform illumination while maintaining the compact and modular nature of the aberration measurement apparatus, making it suitable for integration into a wide range of optical systems without structural modification.

For the purposes of the present invention, the variable focusing optical element is implemented using a Micromirror Array Lens System, which enables precise and high-speed focus variation without macro mechanical movement. However, the system architecture is not limited to this implementation. Alternative technologies, such as liquid crystal variable-focus lenses, may also be employed to dynamically adjust focal length by modulating the refractive index in response to an applied voltage.

The general principle and methods for making the variable focusing optical element are disclosed in U.S. Pat. No. 6,934,072 issued Aug. 23, 2005 to Kim, U.S. Pat. No. 6,934,073 issued Aug. 23, 2005 to Kim, U.S. Pat. No. 6,970,284 issued Nov. 29, 2005 to Kim, U.S. Pat. No. 6,999,226 issued Feb. 14, 2006 to Kim, U.S. Pat. No. 7,031,046 issued Apr. 18, 2006 to Kim, U.S. Pat. No. 7,095,548 issued Aug. 22, 2006 to Cho, U.S. Pat. No. 7,161,729 issued Jan. 9, 2007 to Kim, U.S. Pat. No. 7,239,438 issued Jul. 3, 2007 to Cho, U.S. Pat. No. 7,267,447 issued Sep. 11, 2007 to Kim, U.S. Pat. No. 7,274,517 issued Sep. 25, 2007 to Cho, U.S. Pat. No. 7,489,434 issued Feb. 10, 2009 to Cho, U.S. Pat. No. 7,777.959 issued Aug. 7, 2010 to Sohn, U.S. Pat. No. 7,619,807 issued Nov. 17, 2009 to Baek, all of which are incorporated herein by references.

Although the present invention is briefly summarized, the full understanding of the invention can be obtained by the following drawings, detailed descriptions, and appended claims.

### DESCRIPTION OF FIGURES

These and other features, aspects and advantages of the present invention will become better understood with reference to the accompanying drawings, wherein

FIG. 1 is a schematic diagram of a Shack-Hartmann wavefront sensor, illustrating the principle of wavefront measurement using a microlens array and a sensor to detect local wavefront slopes (prior art);

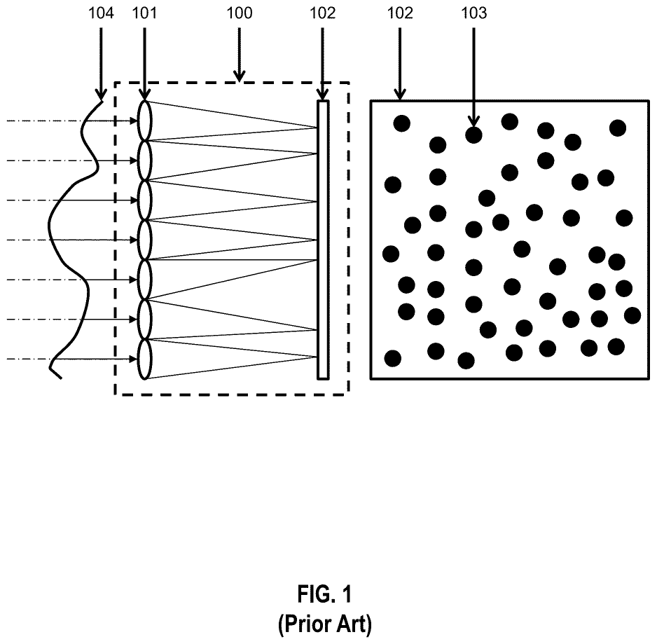

FIG. 2 is a schematic of a Twyman-Green interferometer, illustrating its setup for wavefront measurement using a reference beam and a test beam to generate an interference pattern (prior art);

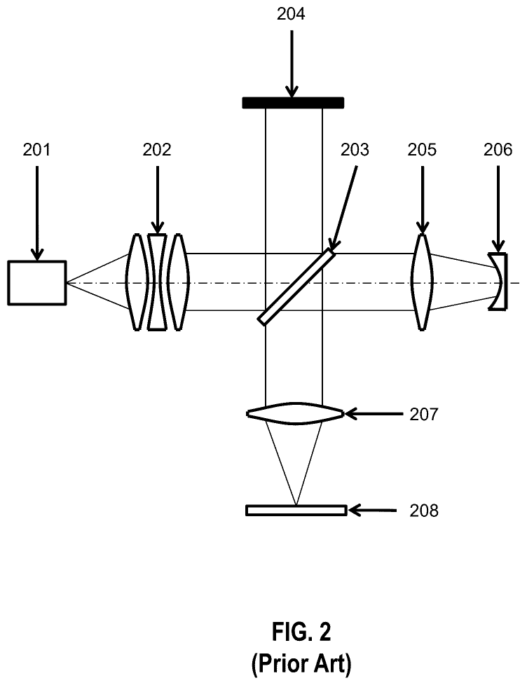

FIG. 3 is a schematic diagram of the aberration measurement apparatus, illustrating the optical unit incorporating a variable focusing optical element. The figure depicts the functional components responsible for high-speed image plane scanning and aberration detection;

FIG. 4 is a schematic diagram of the aberration measurement apparatus, illustrating the integration of the illumination unit with the imaging path;

FIG. 5 is an illustration showing the proposed device with an optical system in place of the camera port, demonstrating how the apparatus is integrated with standard optical systems, such as microscopes, telescopes, and industrial imaging devices;

FIG. 6 illustrates an alternative configuration of the aberration measurement apparatus utilizing a different optical layout;

FIG. 7 illustrates an alternative configuration of the aberration measurement apparatus with coaxial illumination and dual polarizing beam splitter;

FIG. 8 illustrates the optical target used for focus measurement. The target consists of circular patterns designed for precise aberration analysis. The structured layout of these patterns allows for accurate tracking of focus shifts across the image plane;

FIG. 9 shows an image of circular patterns taken by the aberration measurement apparatus. The captured image is analyzed to determine sharpness variations and best focus positions, which are later used in optical aberration quantification;

FIG. 10 illustrates an alternative optical target featuring a square pattern array for aberration measurement. Similar to the circular pattern in FIG. 2, this structured grid of square patterns is designed for precise focus determination and aberration analysis;

FIG. 11 shows an image of square patterns taken by the aberration measurement apparatus. The captured image is analyzed using edge-based detection algorithms to determine sharpness variations and measure focus positions across the field of view;

FIG. 12 depicts a graph of best focus positions for each circular pattern on the optical target. Each point in the graph represents the optimal focus position for the corresponding pattern, allowing the system to identify focus shifts and quantify optical aberrations across the imaging field;

FIG. 13 shows a histogram of Zernike coefficient values, illustrating the distribution and magnitude of different Zernike coefficients calculated from the best focus data.

FIG. 14 is a flowchart outlining the operational process of the aberration measurement apparatus, detailing the steps from image capture to aberration analysis.

### DETAILED DESCRIPTION OF THE ILLUSTRATED EMBODIMENTS

The detailed description of the illustrated embodiments of the invention will now be provided with reference to the accompanying drawings. These embodiments are presented as examples of the invention and are not intended to limit the scope of the claimed invention.

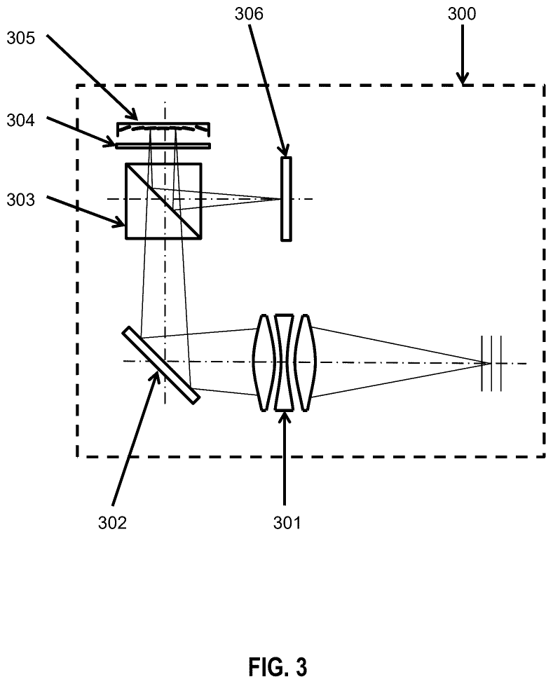

Referring to FIG. 3, an embodiment of the aberration measurement apparatus is illustrated. The optical unit 300 includes several key components that enable precise and rapid image plane scanning. A lens 301 directs incoming light toward the internal optical path of the optical unit, while a mirror 302 redirects the light for compact system integration. A polarizing beam splitter 303 controls light polarization and a retarder 304 modifies the phase of light waves. The variable focusing optical element 305 changes object plane of the optical unit 300 by changing optical power of the variable focusing optical element 305, the image plane of the optical system to be measured (not shown in FIG. 3) can be adjusted accordingly. Finally, a photosensitive optical device 306 captures images of the optical target for further analysis.

The variable focusing optical element 305 allows the optical unit 300 to perform high-speed scanning of the image plane without the need for mechanical movement. The element enables precise control over the focal depth, significantly improving aberration measurement accuracy compared to traditional focusing methods.

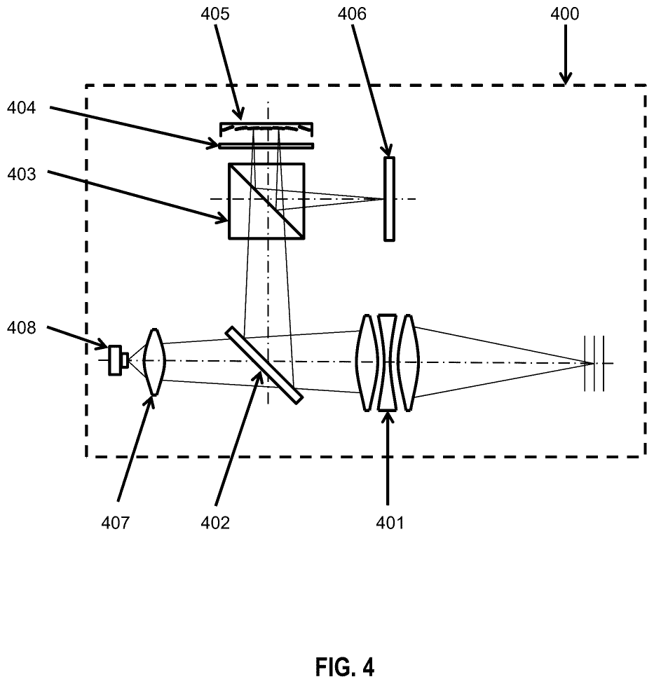

Referring to FIG. 4, the aberration measurement apparatus with an integrated illumination unit is illustrated. This configuration of the optical unit 400 integrates both the imaging and illumination optical paths within a single compact module, improving alignment stability. The optical path includes a lens 401, a beam splitter 402, a polarizing beam splitter 403, a retarder 404, a variable focusing optical element 405, and a photosensitive optical device 406. The beam splitter 402 performs a dual function: it transmits the collimated illumination from the light source toward the optical target, and simultaneously reflects the light returning from the target toward the imaging path. The polarizing beam splitter 403 and retarder 404 manage the polarization state of the light to enhance optical efficiency. The variable focusing optical element 405 dynamically adjusts the image plane without mechanical movement, enabling rapid and precise depth scanning. On the illumination side, a light source 408, such as an LED or laser, emits light that is collimated by a collimating lens 407. The collimated beam enters the imaging path through the beam splitter 402, ensuring uniform and well-controlled illumination of the optical target across the field of view.

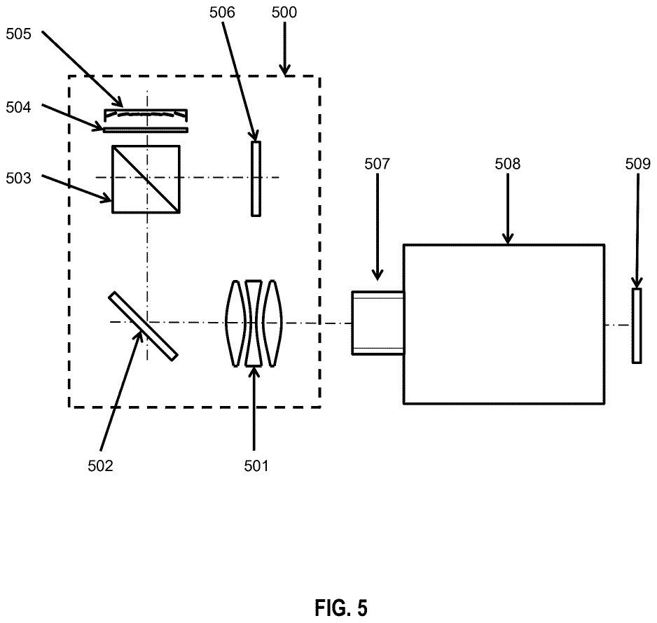

Referring to FIG. 5, the versatility of the aberration measurement apparatus is illustrated in its integration with an optical system 508, such as a microscope or telescope, through a camera port 507. In this configuration, the optical system 508 forms an intermediate image of the optical target 509 at the plane of the camera port 507. The aberration measurement apparatus 500 is attached at this port and is configured to receive and analyze the intermediate image without requiring changes to the optical configuration of the optical system. The intermediate image passes through a lens 501 within the apparatus, which relays the image of the target 509 to the remaining optical components. A mirror 502 directs the incoming light toward a polarizing beam splitter 503 and a retarder 504, which together control the polarization state of the light to improve measurement precision and optical efficiency. The light then passes through a variable focusing optical element 505, which dynamically shifts the image plane without mechanical movement, enabling rapid depth scanning.

The light is captured by a photosensitive optical device 506, which records a sequence of images at different focal depths. These images are analyzed using focus measure functions—such as Sum Modified Laplacian (SML), Gray-Level Local Variance (GLLV), or Tenengrad—to determine the best focus positions. The resulting best focus data is then processed using Zernike polynomial plane fitting to quantify the types and magnitudes of optical aberrations associated with the optical system 508.

The aberration measurement apparatus is designed to be adaptable to a wide range of optical systems 508 without requiring significant modifications to the existing design. This adaptability is achieved through the modular nature of the optical unit 500 and the flexibility of the variable focusing optical element 45, which allows precise control over the image plane.

When integrated with a microscope, for example, the optical unit 500 can be directly attached to the camera port 507, replacing the conventional camera. In this configuration, the optical unit 500 relays the intermediate image formed by the optical system 508 onto the photosensitive optical device 506 located within the unit, preserving the image fidelity and geometry for further analysis. This allows the microscope to perform high-precision aberration measurements without the need for additional optical components or significant alterations to the system's configuration. Furthermore, by eliminating the need for external wavefront sensors or complex interferometric setups, the apparatus simplifies the aberration measurement process while maintaining the full imaging capabilities of the optical system.

The capability of the system to perform rapid and accurate measurements across different optical setups makes it a powerful tool for various applications, including scientific research, industrial inspection, and quality control. By offering a streamlined and efficient method for detecting and analyzing optical aberrations, the present invention significantly enhances the overall performance and reliability of precision optical instruments.

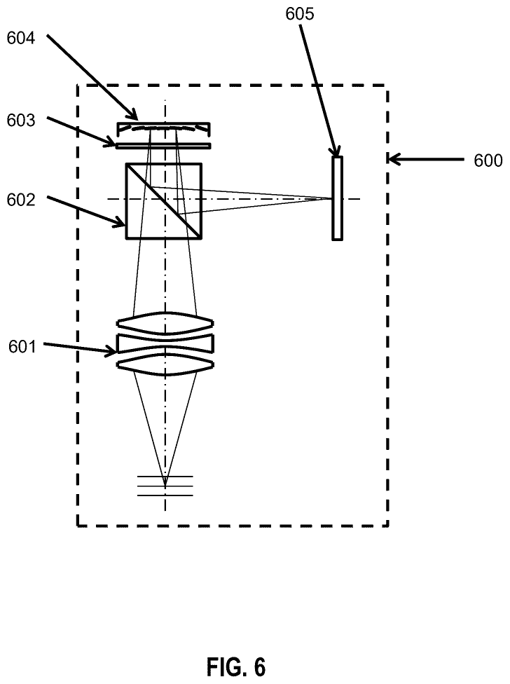

Referring to FIG. 6, an alternative embodiment of the aberration measurement apparatus is illustrated. This configuration utilizes a polarizing beam splitter 602 to control the optical path and direct light towards the variable focusing optical element 603. The optical unit 600 comprises a lens system 601 for focusing the incoming light, the polarizing beam splitter 602 that splits the beam based on polarization states, a variable focusing optical element 604 for dynamic adjustment of the changes object plane of the optical unit 600 by changing the optical power of the variable focusing optical element 604, the image plane of the optical system to be measured can be adjusted accordingly, a retarder 603 for controlling the polarization state, and a photosensitive optical device 605 for capturing the image. This configuration retains the advantages of the previously described embodiment, offering precise aberration measurement without mechanical movement. The use of a polarizing beam splitter enables efficient beam manipulation while maintaining compactness.

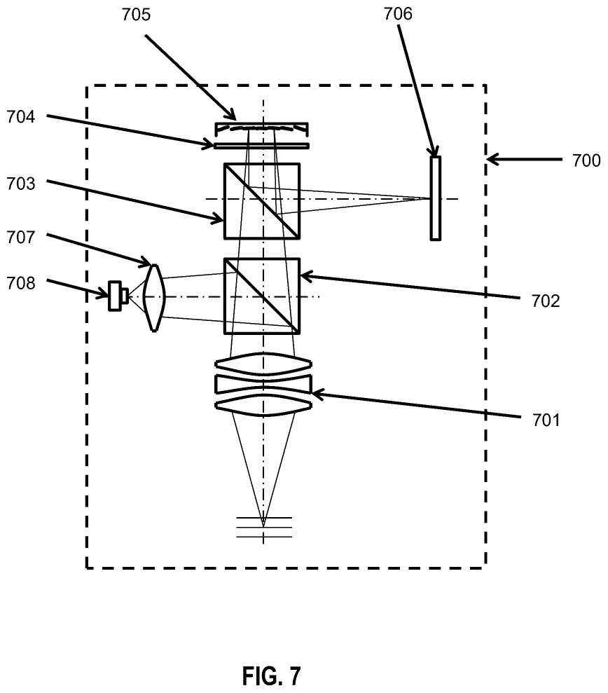

Referring to FIG. 7, an alternative configuration of the aberration measurement apparatus with a dual polarizing beam splitter setup is illustrated. In this embodiment, the illumination path is aligned along the main optical axis, allowing a compact and coaxial design.

The optical unit includes a lens 701, a first polarizing beam splitter 702, a second polarizing beam splitter 703, a retarder 704, a variable focusing optical element 705, and a photosensitive optical device 706. The combination of the second polarizing beam splitter 703 and the retarder 704 enhances optical efficiency by manipulating the polarization state of the light. This enables effective separation and recombination of the illumination and imaging beams within a compact optical layout.

The illumination unit consists of a light source 708, such as an LED or laser, and a collimating lens 707. The collimated illumination beam enters the main optical axis via the first PBS 702. This coaxial configuration ensures precise alignment and uniform illumination across the field of view. By consolidating both illumination and imaging paths within a single optical axis, the system minimizes optical losses, improves stability, and supports high-contrast, high-resolution aberration measurements.

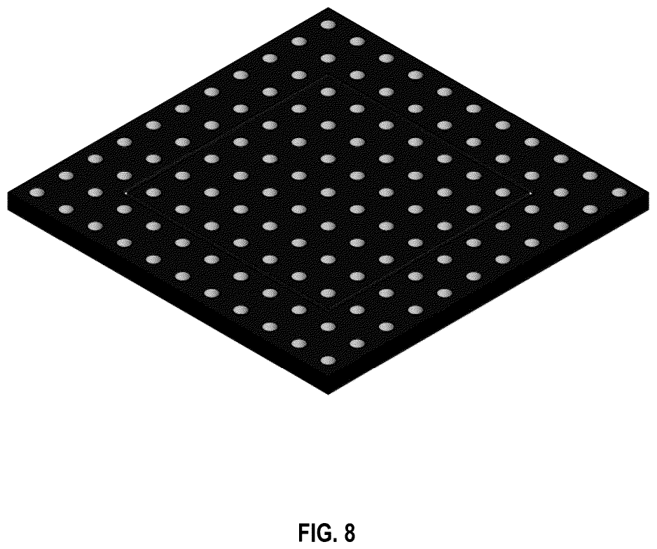

Referring to FIG. 8, the optical target 509 used in the aberration measurement process is illustrated. The optical target 509 is designed to be positioned at a fixed distance from the optical unit 500, ensuring that the captured images remain consistent throughout the scanning process. By maintaining a stable reference, the aberration measurement apparatus can precisely analyze variations in focus, enabling accurate quantification of optical aberrations.

The optical target 509 comprises a circle pattern or other high-contrast features that facilitate accurate image capture and analysis. The high-contrast structure of the optical target 509 enables the system to reliably detect even subtle shifts in focus, which are essential for accurate aberration measurement. Such high-contrast patterns can be fabricated using photolithographic techniques, ensuring sub-micron precision and reproducibility across the target surface. These patterns are typically formed on glass or silicon substrates using chromium or other opaque materials, providing excellent contrast and stability under varying illumination conditions. Maintaining a fixed, well-defined target ensures consistency in measurements and improves the reliability of the extracted aberration data.

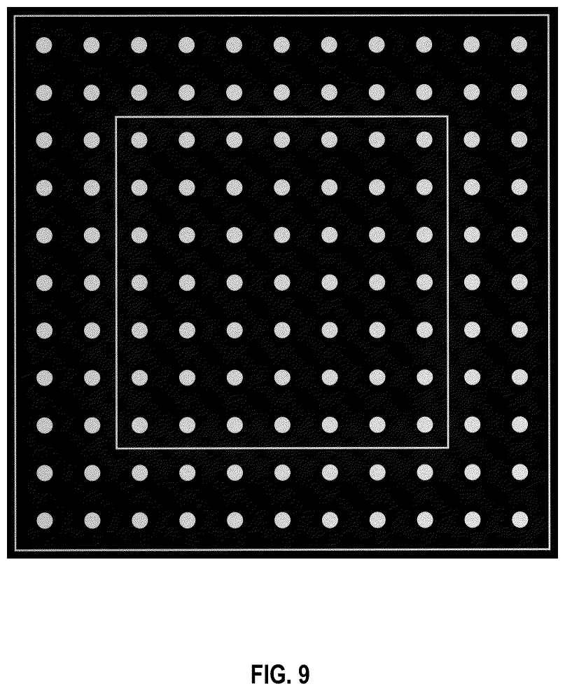

Referring to FIG. 9, an image of the circular patterns captured by the aberration measurement apparatus is shown. The captured image is analyzed to determine sharpness variations across different regions of the target. The system applies a focus measure function—such as the Sum Modified Laplacian (SML), Gray-Level Local Variance (GLLV), or Tenengrad method—to evaluate the sharpness of each region. These algorithms compute local contrast or edge strength to quantify focus quality numerically. The best focus position for each sub-region is determined by identifying the focal depth at which the focus measure reaches its maximum. Once the best focus positions are extracted, the data is plane-fitted using a set of orthogonal Zernike polynomials. This fitting process decomposes the measured focus variation into mathematically defined aberration modes, such as defocus, astigmatism, coma, and spherical aberration. Each Zernike coefficient corresponds to a specific aberration type and magnitude, enabling precise optical characterization.

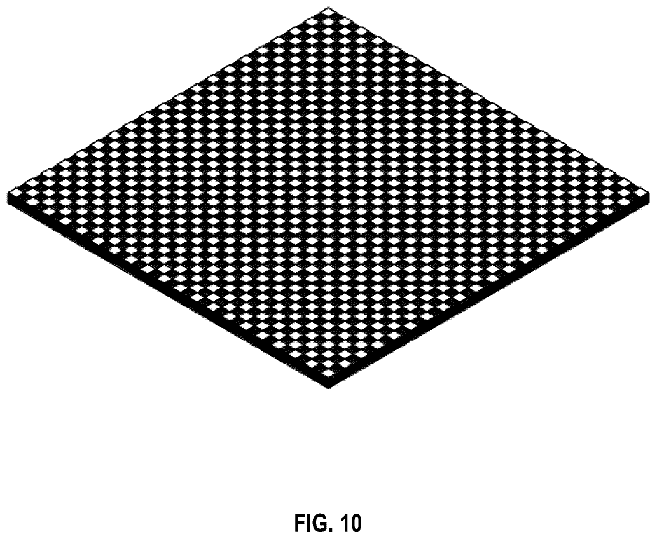

Referring to FIG. 10, an alternative embodiment of the optical target is illustrated. In contrast to the circular pattern target shown in FIG. 8, the square pattern target consists of a structured grid of high-contrast square features, specifically designed for precise aberration measurement and focus analysis.

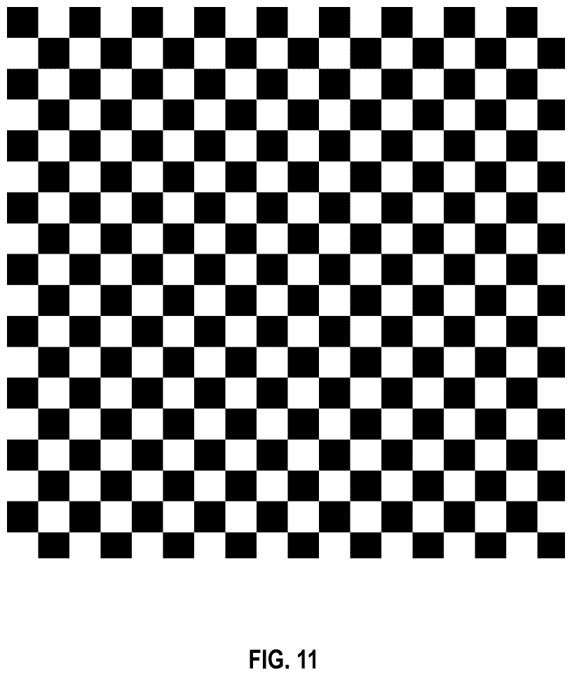

Referring to FIG. 11, an image of the square patterns captured by the aberration measurement apparatus is shown. Similar to FIG. 9, this image is analyzed using edge-based detection algorithms to determine sharpness variations and measure focus positions across the field of view. The sharp edges and well-defined structure of the square pattern enable higher-accuracy aberration measurements providing a more robust dataset for focus analysis.

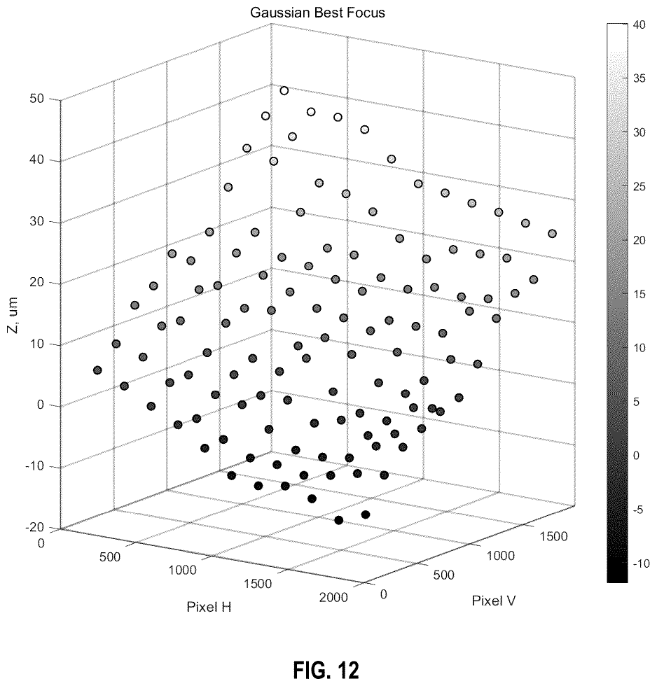

Referring to FIG. 12, a graph of the best focus positions of each circular pattern on the optical target 509 is shown. The positions are determined using a focus measure method, which evaluates the sharpness of the captured images to identify the optimal focal points.

The system implements a combination of focus measure functions, including Sum Modified Laplacian (SML), Gray-Level Local Variance (GLLV), and Tenengrad, each contributing distinct advantages. Sum Modified Laplacian (SML) is highly sensitive to fine image details and performs well in detecting local intensity changes, making it effective for identifying crisp focus regions. Gray-Level Local Variance (GLLV) measures local variance in grayscale intensity, offering robustness to noise and contrast fluctuations. Tenengrad, based on gradient magnitude, provides strong edge-based detection and is particularly effective in scenes with prominent structural features. By integrating these complementary focus measures, the aberration measurement apparatus achieves accurate and noise-resilient best focus estimation.

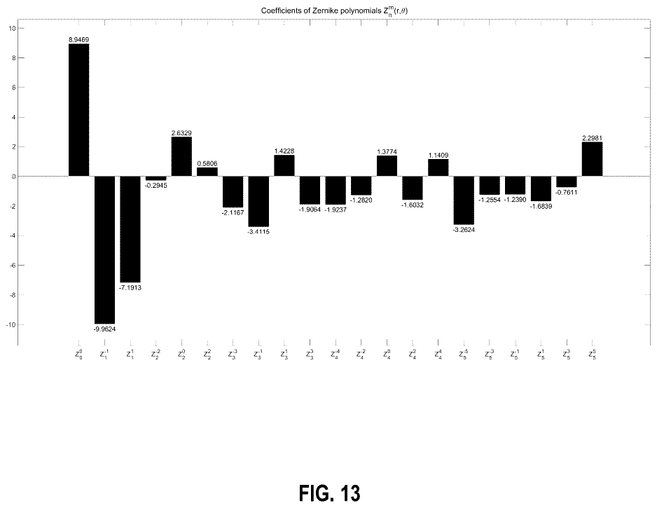

By analyzing the best focus data for multiple points across the target, the system can accurately map focus variations across the image plane. Deviations in best focus positions indicate wavefront distortions and optical aberrations, which are later analyzed using Zernike polynomial decomposition, as illustrated in FIG. 13.

Referring to FIG. 13, a histogram is shown depicting the Zernike coefficient values calculated from the best focus data obtained through the aberration measurement apparatus. Zernike polynomials are a set of orthogonal functions defined over the unit circle, widely used in optical analysis to mathematically represent different types of optical aberrations by decomposing wavefront errors into individual components. Their orthogonality ensures that each aberration term is uniquely and independently quantified, facilitating precise reconstruction and interpretation of complex wavefront distortions.

Each Zernike coefficient corresponds to a specific type of aberration that affects the quality of the optical image. For example, the field curvature term (Z₂⁰) causes field dependent blurring across the entire field, reducing image sharpness. Astigmatism (Z₂², Z₂⁻²) leads to line-shaped distortions, causing points to appear stretched in different directions depending on focus. Coma (Z₃¹, Z₃⁻¹) introduces asymmetry in the image, where point sources appear comet-like, particularly toward the edges of the field. Spherical aberration (Z₄⁰) results in peripheral rays focusing at different depths than central rays, degrading resolution and contrast. Higher-order terms, such as trefoil (Z₃³, Z₃⁻³) or quadrafoil (Z₄⁴, Z₄⁻⁴), introduce more complex distortions affecting high-precision systems. These aberrations are visualized in FIG. 13. The height of each bar indicates the magnitude of the corresponding aberration component, offering a comprehensive view of the wavefront distortion and supporting prioritization of corrective actions based on dominant aberrations.

Additionally, the histogram can be used for trend analysis across different optical configurations, enabling comparative studies of wavefront errors before and after system adjustments. The ability to quantify these aberrations with high precision makes the aberration measurement apparatus a powerful tool for diagnosing and optimizing optical performance across various imaging applications.

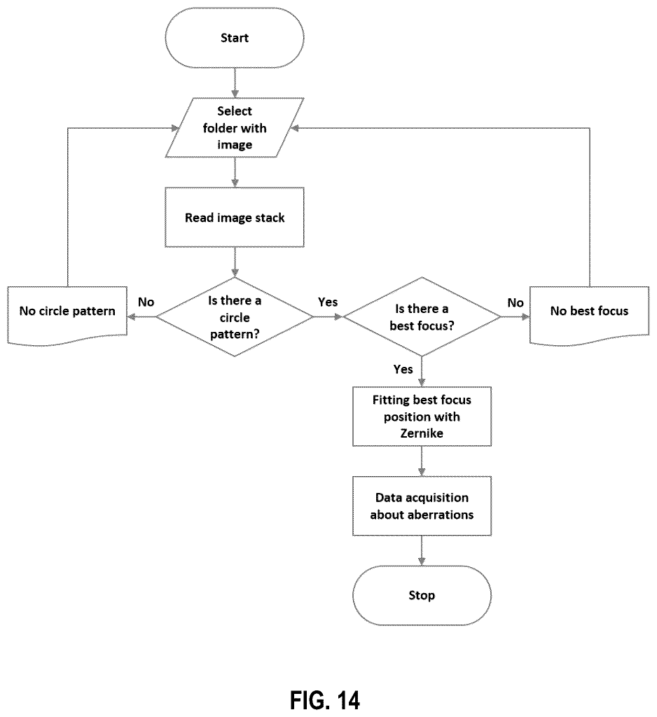

Referring to FIG. 14, a flowchart illustrates the operational steps of the aberration measurement apparatus. The process consists of multiple stages, starting from the initialization of the system and progressing through image acquisition, focus analysis, aberration computation, and system optimization.

The aberration measurement process begins with the setup and initialization of the system. The necessary hardware and software components are prepared to ensure accurate measurement. The optical unit 500, incorporating the variable focusing optical element 505, is attached to the camera port 507 of the optical system 508. The optical target 509, containing structured patterns for focus measurement, is positioned at a fixed reference distance to maintain consistency in image acquisition.

The variable focusing optical element 505 dynamically adjusts the optical focus, thereby enabling high-speed scanning of the image plane. A sequence of images is captured at varying focal depths to allow detailed aberration analysis.

The acquired images are processed using a focus measure function to determine the sharpness of each image. The best focus positions of multiple regions on the optical target 509 are extracted for further processing. The best focus position data is fitted to Zernike polynomials, which mathematically represent optical aberrations.

The Zernike coefficients are computed to classify and quantify the different types of aberrations present in the optical system, such as defocus, astigmatism, coma, and spherical aberration. Based on the aberration analysis, corrective adjustments can be applied to improve optical performance.

The present invention addresses the limitations of existing optical aberration measurement systems by introducing an innovative aberration measurement apparatus and method that leverages the capabilities of a variable focusing optical element. The invention provides a compact, efficient, and highly accurate solution for determining optical aberrations in a wide range of optical systems. The optical unit is designed to be attachable to the camera port of an optical system, such as a microscope or telescope, replacing the standard camera for aberration analysis.

This invention simplifies the measurement process, reduces the need for manual calibration, and enhances the accuracy of aberration detection. The compact design allows the system to be easily adapted to various optical systems, making it a versatile tool for various applications, including scientific research, industrial inspection, and optical quality control. The system operates without requiring mechanical movement of the optical unit, utilizing the variable focusing optical element to dynamically adjust the image plane position.

The variable focusing optical element enables high-speed depth scanning, allowing the system to capture multiple image planes rapidly. The best focus positions are determined using focus measure methods, including Sum Modified Laplacian (SML), Gray-Level Local Variance (GLLV) and Tenengrad, which evaluate image sharpness and extract optimal focal positions. The calculated focus positions are then analyzed using Zernike polynomials, allowing for precise quantification of optical aberrations, such as spherical aberration, coma, astigmatism, and field curvature.

The illumination unit is configured to provide uniform and adjustable illumination across the field of view, ensuring high contrast and precision in aberration measurement. It includes a light source selected from an LED or laser, combined with a collimating lens to direct light onto the target with controlled intensity and uniformity.

The optical unit further incorporates a photosensitive device, such as a complementary metal-oxide-semiconductor (CMOS) or charge-coupled device (CCD) sensor, to capture images of the optical target.

The present invention of an aberration measurement apparatus by fast image plane scanning of an optical system to be measured comprises an optical unit, an optical target, an illumination unit, and corresponding software.

The optical unit in the present invention of the aberration measurement apparatus by fast image plane scanning of an optical system to be measured comprises a variable focusing optical element, wherein the optical unit is attachable to the optical system camera port in place of a camera to quantify optical aberration of the optical system, and wherein the optical unit varies image planes of the optical system and determines best focus position of the optical system with respect to image field of the optical system.

The optical target in the present invention of the aberration measurement apparatus by fast image plane scanning of an optical system to be measured is an image-based optical target to be imaged by the optical system and the optical unit with the variable focusing optical element.

The illumination unit in the present invention of the aberration measurement apparatus by fast image plane scanning of an optical system to be measured-for imaging the target is configured to provide uniform and adjustable illumination across field of view of the optical system, ensuring high contrast and precision in aberration measurement.

The software in the present invention of the aberration measurement apparatus by fast image plane scanning of an optical system to be measured captures images and processes the captured images with the optical unit.

The optical unit in the present invention of the aberration measurement apparatus by fast image plane scanning of an optical system to be measured captures images of the target while varying the image plane of the optical system using the variable focusing optical element in the optical unit, and the software processes the captured images to determine the best focus positions as a function of distance and height of the image plane, and wherein the determined best focus positions are further utilized to quantify the aberration of the optical system.

The optical unit in the present invention of the aberration measurement apparatus by fast image plane scanning of an optical system to be measured is capable of multispectral aberration measurement, enabling analysis of optical aberrations across different wavelengths.

The optical unit in the present invention of the aberration measurement apparatus by fast image plane scanning of an optical system to be measured comprises a photosensitive optical sensor configured to capture area images.

The variable focusing optical element in the optical unit in the present invention of the aberration measurement apparatus by fast image plane scanning of an optical system to be measured is a refractive-type variable focusing lens.

The variable focusing optical element in the optical unit in the present invention of the aberration measurement apparatus by fast image plane scanning of an optical system to be measured is a reflective-type variable focusing mirror.

The variable focusing optical element in the present invention of the aberration measurement apparatus by fast image plane scanning of an optical system to be measured is a Micromirror Array Lens System (MALS).

The optical system for testing in the present invention of the aberration measurement apparatus by fast image plane scanning of an optical system to be measured is a microscope or telescope.

The image processing by the software in the present invention of the aberration measurement apparatus by fast image plane scanning of an optical system to be measured includes applying at least one focus measure function selected from the group consisting of Sum Modified Laplacian (SML), Gray-Level Local Variance (GLLV), and Tenengrad method.

The illumination unit in the present invention of the aberration measurement apparatus by fast image plane scanning of an optical system to be measured includes a light source selected from an LED, a laser, a fluorescence light or an incandescence light, coupled with collimating optics to provide uniform illumination to the target.

The optical unit in the present invention of the aberration measurement apparatus by fast image plane scanning of an optical system to be measured comprises an integrated illumination unit inside the optical unit.

The integrated illumination unit of the optical unit in the present invention of the aberration measurement apparatus by fast image plane scanning of an optical system to be measured is configured in a coaxial geometry.

The present invention presents a new method for quantifying optical aberration by fast image plane scanning of an optical system to be quantified comprises steps of arranging an optical unit, positioning an optical target, illuminating the target, capturing images of the target, determining best focus positions of the optical system, and quantifying optical aberration of the optical system.

First, an optical unit comprising a variable focusing optical element should be arranged. The optical unit in the present invention of the aberration measurement apparatus by fast image plane scanning of an optical system to be measured is designed to be attachable to camera port of the optical system to be measured in place of a camera to quantify optical aberration of the optical system.

Second, an optical target should be positioned at a fixed distance from the optical system. The optical target in the present invention of the aberration measurement apparatus by fast image plane scanning of an optical system to be measured is an image-based optical target to be imaged by the optical system and the optical unit.

Third, the optical target is illuminated using the illumination unit. The illumination unit in the present invention of the aberration measurement apparatus by fast image plane scanning of an optical system to be measured is configured to provide uniform and adjustable illumination across the field of view;

Fourth, the optical target images are captured using while varying image plane of the optical system using the variable focusing optical element in the optical unit in the present invention of the aberration measurement apparatus by fast image plane scanning of an optical system to be measured;

Next software is engaged and determines the best focus positions of the optical system with respect to image field of the optical system and quantifying optical aberrations of the optical system based on the determined best focus positions.

The captured images by the optical unit are processed using computational algorithms to extract wavefront error, enabling high-precision characterization of optical aberrations across the image field.

The software of the optical unit in the present invention of the aberration measurement apparatus by fast image plane scanning of an optical system to be measured controls the variable focusing optical element to achieve precise image plane scanning of optical system.

To have better quality of the data, the optical unit in the present invention of the aberration measurement apparatus by fast image plane scanning of an optical system to be measured should have the step of calibration before measurement to ensure accurate and repeatable aberration quantification.

The optical aberrations measured in the present invention of the aberration measurement apparatus by fast image plane scanning of an optical system to be measured include spherical aberration, coma, astigmatism and field curvature. Those aberrations are quantified by decomposing Zernike polynomials obtained by fitting the best focus positions of the optical system.

The best focus positions in the present invention of the aberration measurement apparatus by fast image plane scanning of an optical system to be measured are determined using a focus measure method, including Sum Modified Laplacian and Gray-Level Local Variance, Tenengrad to evaluate image contrast and determine best focus positions.

An optical unit for quantifying optical aberration in the present invention of the aberration measurement apparatus by fast image plane scanning of an optical system to be measured comprises an imaging optics, an illumination unit, a photosensitive optical sensor, a variable focusing optical element.

The imaging optics in the present invention of the aberration measurement apparatus by fast image plane scanning of an optical system to be measured is configured to define the base optical power of the optical unit, thus determines the best focal position of the optical system to be measured.

The illumination unit in the present invention of the aberration measurement apparatus by fast image plane scanning of an optical system to be measured provides uniform and adjustable illumination across the field of view to enhance contrast and measurement precision. The illumination unit gives better image quality for easier software processing to calculate the best focus positions of the optical system.

The photosensitive optical sensor in the present invention of the aberration measurement apparatus by fast image plane scanning of an optical system to be measured captures area images. Wherein the photosensitive optical sensor is optimized for the spectral range of the optical system to be measured. To have chromatic aberration, the photosensitive optical sensor can further comprise an optical filter or filters to have images with specific wavelengths.

The variable focusing optical element in the present invention of the aberration measurement apparatus by fast image plane scanning of an optical system to be measured varies focal plane of the optical unit. By varying the object plane of the optical unit, thus the image plane of the optical system to be measured.

To have high throughput of the aberration measurements, the optical unit performs high-speed scanning by varying the focal plane using the variable focusing optical element. For the purpose of this high speed measurements, Micromirror Array Lens System is a good candidate for the variable focusing optical element.

The photosensitive optical sensor in the present invention of the aberration measurement apparatus by fast image plane scanning of an optical system to be measured is an area scan camera. Also the photosensitive optical sensor can be a line scan camera. For the line scan camera case, the software processing should be optimized for the line scan camera process.

The photosensitive optical sensor in the present invention of the aberration measurement apparatus by fast image plane scanning of an optical system to be measured is optimized for near-infrared, visible, and ultraviolet light detection, enabling high-precision aberration quantification in different spectral band for different spectral response of the optical system.

The variable focusing optical element in the present invention of the aberration measurement apparatus by fast image plane scanning of an optical system to be measured varies base optical power of the optical unit. Preferably, Micromirror Array Lens System is used for a variable focusing optical element for having high speed of the measurements.

Even though the property of the variable focusing optical element is briefly disclosed in the present invention, the detail about the variable focusing optical element is disclosed in the following patents. The general principle and methods for making the variable focusing optical element are disclosed in U.S. Pat. No. 6,934,072 issued Aug. 23, 2005 to Kim, U.S. Pat. No. 6,934,073 issued Aug. 23, 2005 to Kim, U.S. Pat. No. 6,970,284 issued Nov. 29, 2005 to Kim, U.S. Pat. No. 6,999,226 issued Feb. 14, 2006 to Kim, U.S. Pat. No. 7,031,046 issued Apr. 18, 2006 to Kim, U.S. Pat. No. 7,095,548 issued Aug. 22, 2006 to Cho, U.S. Pat. No. 7,161,729 issued Jan. 9, 2007 to Kim, U.S. Pat. No. 7,239,438 issued Jul. 3, 2007 to Cho, U.S. Pat. No. 7,267,447 issued Sep. 11, 2007 to Kim, U.S. Pat. No. 7,274,517 issued Sep. 25, 2007 to Cho, U.S. Pat. No. 7,489,434 issued Feb. 10, 2009 to Cho, U.S. Pat. No. 7,777.959 issued Aug. 7, 2010 to Sohn, U. S U.S. Pat. No. 7,619,807 issued Nov. 17, 2009 to Baek, all of which are incorporated herein by references.

The general principle, structure and methods for making the micro-electro-mechanical systems device and the variable focusing optical element are disclosed in U.S. Pat. No. 7,330,297 issued Feb. 12, 2008 to Noh, U.S. Pat. No. 7,365,899 issued Apr. 29, 2008 to Gim, U.S. Pat. No. 7,382,516 issued Jun. 3, 2008 to Seo, U.S. Pat. No. 7,400,437 issued Jul. 15, 2008 to Cho, U.S. Pat. No. 7,411,718 issued Aug. 12, 2008 to Cho, U.S. Pat. No. 7,474,454 issued Jan. 6, 2009 to Seo, U.S. Pat. No. 7,488,082 issued Feb. 10, 2009 to Kim, U.S. Pat. No. 7,535,618 issued May 19, 2009 to Kim, U.S. Pat. U.S. Pat. No. 7,898,144 issued Mar. 1, 2011 to Seo, U.S. Pat. No. 7,777.959 issued Aug. 7, 2010 to Sohn, U.S. Pat. No. 7,589,884 issued Sep. 15, 2009 to Sohn, U.S. Pat. No. 7,589,885 issued Sep. 15, 2009 to Sohn, U.S. Pat. No. 7,605,964 issued Oct. 20, 2009 to Gim, and U.S. Pat. No. 9,505,606 issued Nov. 29, 2016 to Sohn, U.S. Pat. No. 8,687,276 issued Jul. 28, 2011 to Cho, U.S. Pat. Pub. No 2009/0303569 published Dec. 10, 2009, all of which are incorporated herein by references.

The general properties of the variable focusing optical element are disclosed in U.S. Pat. No. 7,173,653 issued Feb. 6, 2007 to Gim, U.S. Pat. No. 7,215,882 issued May 8, 2007 to Cho, U.S. Pat. No. 7,236,289 issued Jun. 26, 2007 to Baek, U.S. Pat. No. 7,354,167 issued Apr. 8, 2008 to Cho, U.S. Pat. No. 9,565,340 issued Feb. 7, 20017 to Seo, U.S. Pat. No. 9,736,346 issued Aug. 15, 2017 to Baek, all of which are incorporated herein by references.

The general principle, methods for making the micro-electro-mechanical systems device and variable focusing optical element, and their applications are disclosed in U.S. Pat. No. 7,057,826 issued Jun. 6, 2006 to Cho, U.S. Pat. No. 7,068,416 issued Jun. 27, 2006 to Gim, U.S. Pat. No. 7,077,523 issued Jul. 18, 2006 to Seo, U.S. Pat. No. 7,261,417 issued Aug. 28, 2007 to Cho, U.S. Pat. No. 7,315,503 issued Jan. 1, 2008 to Cho, U.S. Pat. No. 7,333,260 issued Feb. 19, 2008 to Cho, U.S. Pat. No. 7,339,746 issued Mar. 4, 2008 to Kim, U.S. Pat. No. 7,350,922 issued Apr. 1, 2008 to Seo, U.S. Pat. No. 7,768,571 issued Aug. 3, 2010 to Kim, U.S. Pat. No. 7,742,232 issued Jun. 22, 2010 to Cho, and U.S. Pat. No. 8,049,776 issued Nov. 1, 2011 to Seo, U.S. Pat. No. 7,212.330 issued May 1, 2007 to Seo, U.S. Pat. No. 7,580.178 issued Aug. 25, 2009 issued to Cho, U.S. Pat. No. 7,751,694 issued Jul. 6, 2010 to Cho, U. S Pat. No. 7,410.266 issued Aug. 12, 2008 to Seo, U.S. Pat. No. 7,619,614 issued Nov. 17, 2009 to Baek, U.S. Pat. No. 7,667,896 issued Feb. 23, 2010 to Seo, U.S. Pat. No. 8,810,908 issued Sep. 24, 2009 to Kim, U.S. Pat. No. 8,622,557 issued Nov. 26, 2009 to Cho, U.S. Pat. No. 7,605,989 issued Oct. 20, 2009 to Sohn, U.S. Pat. No. 8,345,146 issued Mar. 31, 2011 to Cho, U.S. Pat. Pub. No. 2006/0203117 published Sep. 14, 2006, U.S. Pat. Pub. No. 2007/0041077 published Feb. 22, 2007, U.S. Pat. Pub. No. 2007/0040924 published Feb. 22, 2007, U.S. Pat. Pub. No. 2009/0185067 published Jul. 23, 2009, U.S. Pat. Pub. No. 2012/0133761 published May. 31, 2012, U.S. Pat. App. Ser. No 15/333/188 filed Oct. 25, 2016, all of which are incorporated herein by references.

The general principle, structure and methods for making the discrete motion control of micro-electro-mechanical systems device are disclosed in U.S. Pat. No. 7,330,297 issued Feb. 12, 2008 to Noh, U.S. Pat. No. 7,365,899 issued Apr. 29, 2008 to Gim, U.S. Pat. No. 7,382,516 issued Jun. 3, 2008 to Seo, U.S. Pat. No. 7,400,437 issued Jul. 15, 2008 to Cho, U.S. Pat. No. 7,411,718 issued Aug. 12, 2008 to Cho, U.S. Pat. No. 7,474,454 issued Jan. 6, 2009 to Seo, U.S. Pat. No. 7,488,082 issued Feb. 10, 2009 to Kim, U.S. Pat. No. 7,535,618 issued May 19, 2009 to Kim, U.S. Pat. No. 7,898,144 issued Mar. 1, 2011 to Seo, U.S. Pat. No. 7,777,959 issued Aug. 17, 2010 to Sohn, U.S. Pat. No. 7,589,884 issued Sep. 15, 2009 to Sohn, U.S. Pat. No. 7,589,885 issued Sep. 15, 2009 to Sohn, U.S. Pat. No. 7,605,964 issued Oct. 20, 2009 to Gim, and U.S. Pat. No. 9,505,606 issued Nov. 29, 2016 to Sohn, all of which are incorporated herein by references.

While the invention has been shown and described with reference to different embodiments thereof, it will be appreciated by those skills in the art that variations in form, detail, compositions and operation may be made without departing from the spirit and scope of the invention as defined by the accompanying claims.

This research was financially supported by the Institute of Civil Military Technology Cooperation funded by the Defense Acquistion Program Administration and Ministry of Trade, Industry and Energy of Korean government under grant No.22-CM-EO-06.

What is claimed is:

1. An aberration measurement apparatus by fast image plane scanning of an optical system to be measured comprising:
a. an optical unit, wherein the optical unit comprises a variable focusing optical element, wherein the optical unit is attachable to the optical system camera port in place of a camera to quantify optical aberration of the optical system, and wherein the optical unit varies image planes of the optical system and determines best focus position of the optical system with respect to image field of the optical system;
b. a target, wherein the target is an image-based optical target to be imaged by the optical system and the optical unit with the variable focusing optical element;
c. an illumination unit-for imaging the target, wherein the illumination unit is configured to provide uniform and adjustable illumination across field of view of the optical system, ensuring high contrast and precision in aberration measurement; and
d. a software, wherein the software captures images and processes the captured images with the optical unit;
wherein the optical unit captures images of the target while varying the image plane of the optical system using the variable focusing optical element in the optical unit, and the software processes the captured images to determine the best focus positions as a function of distance and height of the image plane, and wherein the determined best focus positions are further utilized to quantify the aberration of the optical system.

2. The aberration measurement apparatus by fast image plane scanning in claim 1, wherein the optical unit is capable of multispectral aberration measurement, enabling analysis of optical aberrations across different wavelengths.

3. The aberration measurement apparatus by fast image plane scanning in claim 1, wherein the optical unit comprises a photosensitive optical sensor configured to capture area images.

4. The aberration measurement apparatus by fast image plane scanning in claim 1, wherein the variable focusing optical element is a refractive-type variable focusing lens.

5. The aberration measurement apparatus by fast image plane scanning in claim 1, wherein the variable focusing optical element is a reflective-type variable focusing mirror.

6. The aberration measurement apparatus by fast image plane scanning in claim 1, wherein the variable focusing optical element is a Micromirror Array Lens System (MALS).

7. The aberration measurement apparatus by fast image plane scanning in claim 1, wherein the optical system for testing is a microscope or telescope.

8. The aberration measurement apparatus by fast image plane scanning in claim 1, wherein the image processing includes applying at least one focus measure function selected from the group consisting of Sum Modified Laplacian (SML), Gray-Level Local Variance (GLLV), and Tenengrad method.

9. The aberration measurement apparatus by fast image plane scanning in claim 1, wherein the illumination unit includes a light source selected from an LED, a laser, a fluorescence light or an incandescence light, coupled with collimating optics to provide uniform illumination to the target.

10. The aberration measurement apparatus by fast image plane scanning in claim 1, wherein the optical unit comprises an integrated illumination unit inside the optical unit.

11. The aberration measurement apparatus by fast image plane scanning in claim 10, wherein the integrated illumination unit is configured in a coaxial geometry.

12. A method for quantifying optical aberration by fast image plane scanning of an optical system to be quantified comprises steps of:
a. arranging an optical unit comprising a variable focusing optical element, wherein the optical unit is attachable to camera port of the optical system in place of a camera to quantify optical aberration of the optical system;
b. positioning a target at a fixed distance from the optical system, wherein the target is an image-based optical target to be imaged by the optical system and the optical unit;
c. illuminating the target using an illumination unit, wherein the illumination unit is configured to provide uniform and adjustable illumination across the field of view;
d. capturing images of the target while varying image plane of the optical system using the variable focusing optical element;
e. determining best focus positions of the optical system with respect to image field of the optical system; and
f. quantifying optical aberrations of the optical system based on the determined best focus positions,
wherein the captured images are processed using computational algorithms to extract wavefront error, enabling high-precision characterization of optical aberrations across the image field.

13. The method for quantifying optical aberration with fast image plane scanning in claim 12, wherein the software of the optical unit controls the variable focusing optical element to achieve precise image plane scanning of optical system.

14. The method for quantifying optical aberration with fast image plane scanning in claim 12 further comprising the step of calibrating the optical unit before measurement to ensure accurate and repeatable aberration quantification.

15. The method for quantifying optical aberration with fast image plane scanning in claim 12, wherein the optical aberrations include spherical aberration, coma, astigmatism and field curvature, are quantified by decomposing Zernike polynomials by fitting the best focus positions of the optical system.

16. The method for quantifying optical aberration with fast image plane scanning in claim 12, wherein the best focus positions are determined using a focus measure method, including Sum Modified Laplacian and Gray-Level Local Variance, Tenengrad to evaluate image contrast and determine best focus positions.

17. An optical unit for quantifying optical aberration by fast image plane scanning, comprising:
a. an imaging optics, wherein the imaging optics configured to define the base optical power of the optical unit;
b. an illumination unit, wherein the illumination unit providing uniform and adjustable illumination across the field of view to enhance contrast and measurement precision;
c. a photosensitive optical sensor, wherein the optical sensor captures area images;
d. a variable focusing optical element, wherein the variable focusing optical element varies focal plane of the optical unit;
wherein the optical unit performs high-speed scanning by varying the focal plane using the variable focusing optical element.

18. The optical unit for quantifying optical aberration of claim 17, wherein the photosensitive optical sensor is an area scan camera.

19. The optical unit for quantifying optical aberration of claim 17, wherein the photosensitive optical sensor is optimized for the spectral range of the optical system to be measured.

20. The optical unit for quantifying optical aberration of claim 17, wherein the photosensitive optical sensor further comprises an optical filter or filters to have images with specific wavelengths to have specific chromatic aberration measurements.

21. The optical unit for quantifying optical aberration of claim 17, wherein the photosensitive optical sensor is optimized for near-infrared, visible, and ultraviolet light detection, enabling high-precision aberration quantification in different spectral band.

22. The optical unit for quantifying optical aberration of claim 17, wherein the variable focusing optical element varies base optical power of the optical unit.
